(19) United States
(12) Patent Application Publication
(10) Pub. No.: US 2014/0216661 A1
(43) Pub. Date: Aug. 7, 2014

(54) LABEL ATTACHMENT DEVICE

(71) Applicants: Hiroshi Sugimoto, Osakasayama-shi (JP); Satoshi Nii, Kobe-shi (JP)

(72) Inventors: Hiroshi Sugimoto, Osakasayama-shi (JP); Satoshi Nii, Kobe-shi (JP)

(73) Assignee: FUJI SEAL INTERNATIONAL, INC., Osaka-shi, Osaka (JP)

(21) Appl. No.: 14/343,129

(22) PCT Filed: Sep. 6, 2011
(86) PCT No.: PCT/JP2011/070241

§ 371 Date: Mar. 6, 2014

(51) Int. Cl. B65C 9/26; B65C 3/08; B65C 9/00

(52) U.S. Cl. CPC B65C 9/26; B65C 9/0015; B65C 3/08
USPC 156/443

(57) ABSTRACT

The present invention includes clamp members, which preliminarily open a tubular label folded in a sheet; openable and closable expansion claws, which expand the preliminarily opened label; and a mounting, on which a bottle is mounted and which can rise and fall. The mounting on which the bottle is mounted rises, thereby inserting the bottle into the expanded label, and the expansion claws are removed from the label, thereby attaching the label to the bottle. A cam included in a rise and fall mechanism, which causes the expansion claw to rise and fall, includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion.

### TECHNICAL FIELD

The invention relates to a label attachment device for attaching a tubular label such as a stretch label to an attachment target object such as a jar or a bottle.

### BACKGROUND ART

For example, as a label attachment device that attaches a tubular stretch label to the outer peripheral surface of a main body portion of a bottle such as a PET bottle, which serves as a beverage container, there is a rotary label attachment device including a plurality of attachment heads. As shown in (a) of FIG. 14, each attachment head includes: a pair of openable and closable opening arms 71, which preliminarily open a tubular stretch label supplied as folded in a sheet, and have suction portions at their extremities; a pair of openable and closable expansion claws 72, which expand the stretch label opened by the opening arms 71, more widely than the outer diameter of a bottle; and a mounting 73, which rises and falls with a bottle B mounted thereon.

In such a label attachment device, a tubular stretch label L is attached to the bottle B as follows. First, as shown in (a) of FIG. 14, the opening arms 71 hold the tubular stretch label L supplied as folded in a sheet. Then, with the held stretch label L held by suction by the suction portions, as shown in (b) of FIG. 14, the holding surfaces of the opening arms 71 separate from each other to preliminarily open the stretch label L folded in a sheet.

Next, as shown in (c) of FIG. 14, the opening arms 71 fall, thereby attaching the open stretch label L onto the expansion claws 72 in a closed state. Then, as shown in (d) of FIG. 14, the expansion claws 72 open, thereby expanding a lower end portion of the stretch label L. At this time, the opening arms 71 hold the expanded portion of the stretch label L, thereby holding the lower end portion of the stretch label L by the expansion claws 72.

Subsequently, as shown in (e) of FIG. 14, the mounting 73 on which the bottle B is mounted rises, thereby inserting the bottle B into the expanded stretch label L. Then, as shown in (f) of FIG. 14, the opening arms 71 holding the expanded portion of the stretch label L hold an upper end portion of the stretch label L that is not expanded, thereby holding the upper end portion of the stretch label L on the bottle B.

Then, as shown in (g) of FIG. 14, the mounting 73 further rises, thereby removing the expansion claws 72 from the stretch label L and completely attaching the stretch label L to the bottle B. Finally, as shown in (h) of FIG. 14, the mounting 73 falls with the opening arms 71 and the expansion claws 72 being more open, whereby the bottle B to which the stretch label L is attached withdraws from the label attachment level, and is discharged from a predetermined bottle discharge position.

### CITATION LIST

### Patent Literature

[PTL 1] Japanese Laid-Open Patent Publication No. 2002-284130

### SUMMARY OF THE INVENTION

### Problems to be Solved by the Invention

Incidentally, as described above, in a label attachment device of a type that raises the mounting 73 on which the bottle B is mounted, thereby inserting the bottle B into the expanded stretch label L, generally, as shown in (a) of FIG. 15, a rise and fall mechanism 74 causes the mounting 73 to rise and fall. The rise and fall mechanism 74 includes: a cam follower 75, which is attached directly or via another member to the mounting 73; and a cam 76, which is disposed along the movement path of the mounting 73 and has a cam surface 76a that guides the cam follower 75.

Thus, if an attempt is made to change the height of attachment of the label L to the bottle B in this kind of label attachment device, then as shown in (b) of FIG. 15, the cam 76 needs to be exchanged for a cam 76A, which can lift the mounting 73 to the height of attachment of the stretch label L to be changed. The cams, however, are large heavy objects, and therefore, a user themselves cannot easily exchange them. Thus, the reality is that the height of attachment of the stretch label L cannot be substantially changed or finely adjusted.

It is an objective of the invention to provide a label attachment device that allows a user to easily change the height of attachment of a label.

### Solution to the Problems

To achieve the above object, a label attachment device in accordance with a first embodiment includes: a label opening unit configured to preliminarily open a tubular label supplied as folded in a sheet; a label expansion unit having openable and closable expansion claws configured to expand the label preliminarily opened by the label opening unit; and a mounting, on which an attachment target object is mounted and which can rise and fall, wherein the mounting on which the attachment target object is mounted rises, thereby inserting the attachment target object into the tubular label expanded by the expansion claws, and the expansion claws are removed from the label, thereby attaching the label to the attachment target object that is moving along a predetermined movement path. The label attachment device further includes a rise and fall mechanism configured to cause the expansion claws to rise and fall. The rise and fall mechanism includes: a cam follower attached to the label expansion unit; and a cam disposed along movement paths of the expansion claws and configured to guide the cam follower. The cam includes an adjustment mechanism which adjusts height positions of the expansion claws, the adjustment mechanism adjusts height positions of the expansion claws, and thereby can adjust a position of attachment of the label to the attachment target object.

A label attachment device in accordance with a second embodiment is the device of the first embodiment, wherein the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion. The rise and fall portion adjusts height positions of the expansion claws.

A label attachment device in accordance with a third embodiment is the device of the first embodiment, wherein in the cam including the adjustment mechanism, a portion corresponding to an operation of inserting the attachment target object into the tubular label is a movable portion slidable obliquely upward and downward or slidable upward and downward, so that the movable portion is slid obliquely upward and downward or slid upward and downward, thereby adjusting height positions of the expansion claws.

A label attachment device in accordance with a fourth embodiment includes: a label opening unit configured to preliminarily open a tubular label supplied as folded in a sheet; a label expansion unit having openable and closable expansion claws configured to expand the label preliminarily opened by the label opening unit; and a mounting, on which an attachment target object is mounted and which can rise and fall, wherein the mounting on which the attachment target object is mounted rises, thereby inserting the attachment target object into the tubular label expanded by the expansion claws, and the expansion claws are removed from the label, thereby attaching the label to the attachment target object that is moving along a predetermined movement path. The label attachment device further includes a rise and fall mechanism configured to cause the mounting to rise and fall. The rise and fall mechanism includes: a cam follower attached directly or via another member to the mounting; and a cam disposed along a movement path of the mounting and configured to guide the cam follower. The cam includes an adjustment mechanism which adjusts a height position of a stoppage of the mounting, when the mounting on which the attachment target object is mounted rises to insert the attachment target object into the tubular label, the adjustment mechanism adjusts a height position of a stoppage of the mounting, and thereby can adjust a position of attachment of the label to the attachment target object.

A label attachment device in accordance with a fifth embodiment is the device of the fourth embodiment, wherein the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and the rise and fall portion adjusts a height position of a stoppage of the mounting.

A label attachment device in accordance with a sixth embodiment is the device of the fourth embodiment, wherein in the cam including the adjustment mechanism, a portion corresponding to an operation of inserting the attachment target object into the tubular label is a movable portion slidable obliquely upward and downward or slidable upward and downward, so that the movable portion is slid obliquely upward and downward or slid upward and downward, thereby adjusting a position of a stoppage of a rise of the mounting.

A label attachment device in accordance with a seventh embodiment includes: a label opening unit configured to preliminarily open a tubular label supplied as folded in a sheet; a label expansion unit having openable and closable expansion claws configured to expand the label preliminarily opened by the label opening unit; and a mounting, on which an attachment target object is mounted, wherein the expansion claws fall with the tubular label expanded, thereby attaching the tubular label onto the attachment target object, and the expansion claws are removed from the label, thereby attaching the label to the attachment target object that is moving along a predetermined movement path. The label attachment device further includes a rise and fall mechanism configured to cause the expansion claws to rise and fall. The rise and fall mechanism includes: a cam follower attached to the label expansion unit; and a cam disposed along movement paths of the expansion claws and configured to guide the cam follower. The cam includes an adjustment mechanism which adjusts a height position of a stoppage of the expansion claws, when the expansion claws expanding the tubular label fall to attach the tubular label onto the attachment target object, the adjustment mechanism adjusts a height position of a stoppage of the expansion claws.

A label attachment device in accordance with an eighth embodiment is the device of the seventh embodiment, wherein the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and the rise and fall portion adjusts a height position of a stoppage of the expansion claws.

A label attachment device in accordance with a ninth embodiment is the device of the seventh embodiment, wherein in the cam including the adjustment mechanism, a portion corresponding to an operation of attaching the tubular label onto the attachment target object is a movable portion slidable obliquely upward and downward or slidable upward and downward, so that the movable portion is slid obliquely upward and downward or slid upward and downward, thereby causing the expansion claws expanding the tubular label to fall to adjust a position of a stoppage of the fall of the expansion claws when the tubular label is attached onto the attachment target object.

A label attachment device in accordance with a tenth embodiment includes: a label opening unit configured to preliminarily open a tubular label supplied as folded in a sheet; a label expansion unit having openable and closable expansion claws configured to expand the label preliminarily opened by the label opening unit; and a mounting, on which an attachment target object is mounted, wherein the expansion claws fall with the tubular label expanded, thereby attaching the tubular label onto the attachment target object, and the expansion claws are removed from the label, thereby attaching the label to the attachment target object that is moving along a predetermined movement path. The label attachment device further includes a rise and fall mechanism configured to cause the mounting to rise and fall. The rise and fall mechanism includes: a cam follower attached directly or via another member to the mounting; and a cam disposed along a movement path of the mounting and configured to guide the cam follower. The cam includes an adjustment mechanism which adjusts height positions of the mounting. The adjustment mechanism adjusts a height position of the mounting, and thereby can adjust a position of attachment of the label to the attachment target object.

A label attachment device in accordance with a eleventh embodiment is the device of the tenth embodiment, wherein the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and the rise and fall portion adjusts a height position of the mounting.

A label attachment device in accordance with a twelfth embodiment is the device of the tenth embodiment, wherein in the cam including the adjustment mechanism, a portion corresponding to an operation of attaching the tubular label onto the attachment target object is a movable portion slidable obliquely upward and downward or slidable upward and downward, so that the movable portion is slid obliquely upward and downward or slid upward and downward, thereby adjusting a height position of the mounting.

### Advantageous Effects of the Invention

As described above, the label attachment device offers advantageous effects. It allows users themselves to perform a model changing operation more easily than exchanging the entirety of the cam member. In addition, users themselves are enabled to finely adjust the position of attachment of a label. Further, the occurrences of wasted movement time and wasted movement space can be prevented. Moreover, efficient operation of a label attachment device is possible.

### BRIEF DESCRIPTION OF THE DRAWINGS

FIG. 1 is a schematic plan view of a label attachment system including an embodiment of a label attachment device according to the invention.

FIG. 2 is a schematic side view of the label attachment device.

FIG. 3 is a schematic view of one of label attachment heads of the label attachment device.

FIG. 4 is a cross-sectional view of a label expansion unit included in the label attachment device.

FIG. 5 is a plan view of a cam member included in a rise and fall mechanism that causes the label expansion unit to rise and fall.

FIG. 6 is a side view of the cam member.

FIG. 7 is a partial detailed view of the state of attachment of a rise and fall portion and a connection portion included in the cam member, as viewed from above.

FIG. 8, (a) is a cross-sectional view of the state where a mounting of a bottle lifting unit 40 included in the label attachment device has risen, and (b) is a cross-sectional view of the state where the mounting has fallen.

FIG. 9 is a schematic side view of a bottle pull-up unit 50 included in the label attachment device.

FIG. 10 is an operation illustration of a label attachment operation of the label attachment device.

FIG. 11 is an operation illustration of the label attachment operation of the label attachment device.

FIG. 12 is a side view of a cam mounted on a label attachment device according to another embodiment.

FIG. 13 is a side view of a cam mounted on a label attachment device according to another embodiment.

FIG. 14 is an operation illustration of a label attachment operation of a conventional label attachment device.

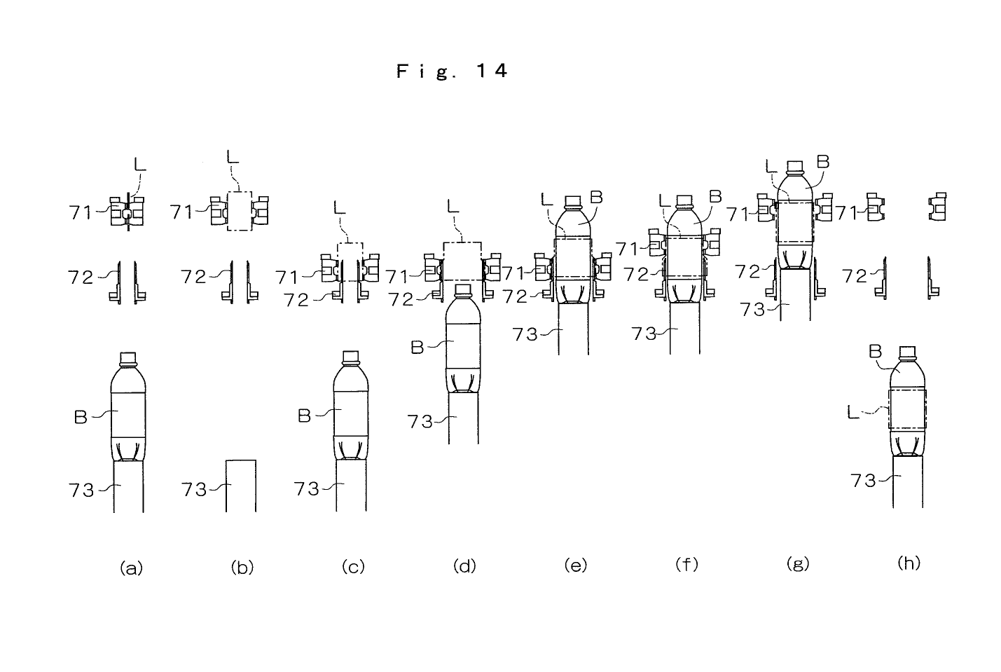

FIG. 15 is a diagram illustrating a problem of the conventional label attachment device.

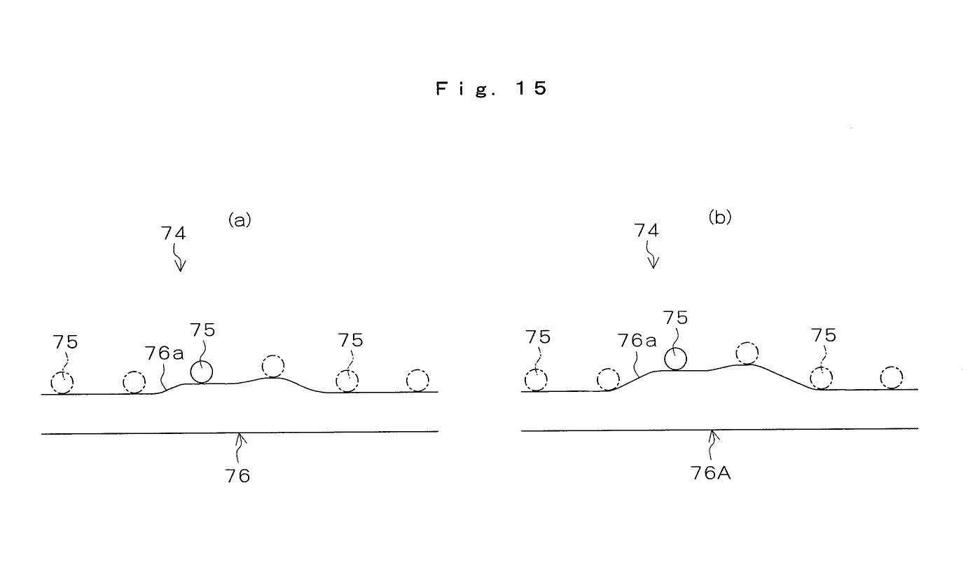

### DESCRIPTION OF EMBODIMENTS

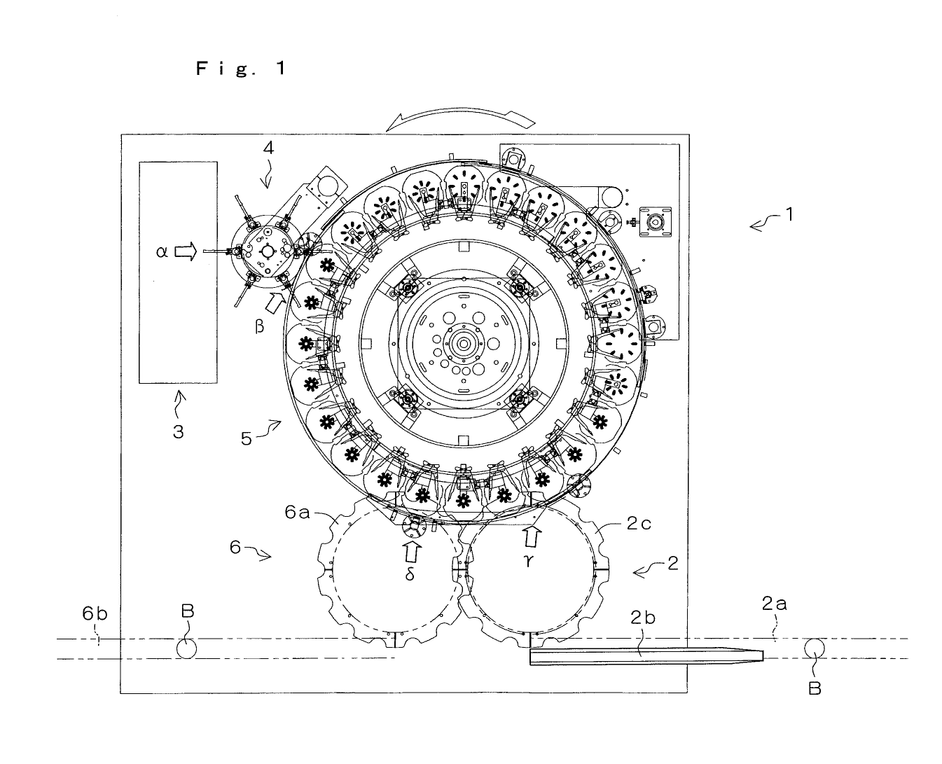

With reference to the drawings, embodiments are described below. FIG. 1 shows a label attachment system 1 for attaching a tubular stretch label (hereinafter referred to as a “label”), formed of an elastic and stretchable film made of a polyethylene resin, to a PET bottle (hereinafter referred to as a “bottle”) B. The label attachment system 1 includes: a bottle supply device 2, which includes a belt conveyor 2a, a screw 2b, and a star wheel 2c; a label supply device 3, which forms labels by sequentially cutting an elongated label forming base material fed from a base material roll by a base material feeding section, and sequentially supplies the labels to a first label delivery position α; a label delivery device 4, which receives the labels supplied to the first label delivery position α by the label supply device 3, and conveys the labels to a second label delivery position β; a rotary label attachment device 5, which receives at a bottle supply position γ the bottle B supplied from the bottle supply device 2 and conveys the bottle B to a bottle sending position δ, and which also receives at the second label delivery position β a label conveyed by the label delivery device 4 and attaches the label to the bottle B while conveying the bottle B from the bottle supply position γ to the bottle sending position 5; and a bottle conveyance device 6, which includes a star wheel 6a and a belt conveyor 6b, which carry out the bottle B to which the label has been attached by the label attachment device 5.

It should be noted that the label forming base material is a material in which tubular labels to be attached to the bottle B are continuously connected to each other, and is wound around a drum while being folded in a sheet at the base material feeding section.

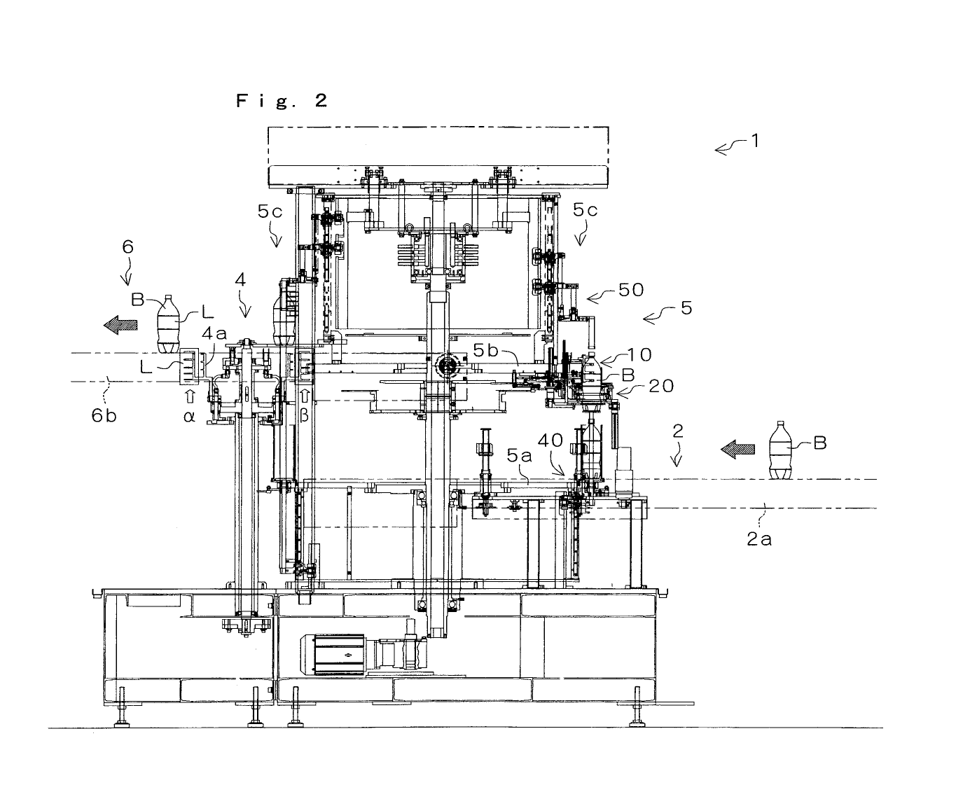

As shown in FIGS. 1 and 2, the label attachment device 5 includes many label attachment heads 5c attached in a concentric circle about a rotating shaft (not shown) at regular intervals, via a supporting disk 5a attached to the rotating shaft and a plurality of supporting arms 5b, 5b projecting from the rotating shaft. Each label attachment head 5c expands a tubular label L folded in a sheet and received at the second label delivery position β, more widely than the outer diameter of the bottle B. Then, the expanded label L becomes attached to a main body portion of the bottle B while the bottle B received at the bottle supply position γ is being conveyed to the bottle sending position δ.

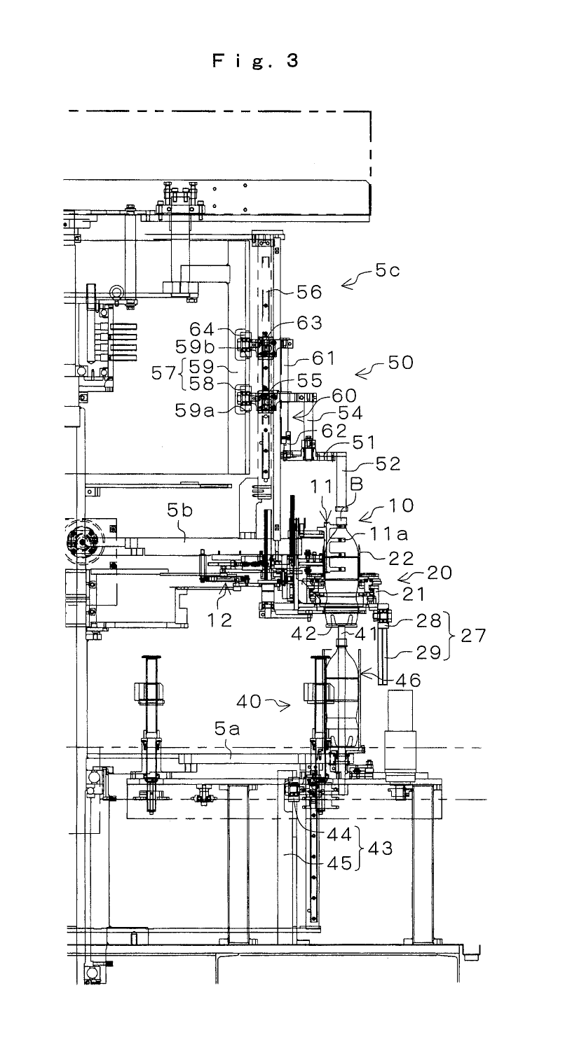

As shown in FIG. 3, the label attachment head 5c includes: a label opening unit 10, which preliminarily opens the tubular label L folded in a sheet and received at the second label delivery position β; a label expansion unit 20, which expands the label L preliminarily opened by the label opening unit 10, more widely than the outer diameter of the bottle B at a label attachment level; a bottle lifting unit 40, which raises a mounting 42 to insert the bottle B, mounted on the mounting 42 at a position below the label attachment level at the bottle supply position γ, into the label L expanded at the label attachment level; and a bottle pull-up unit 50, which lifts the bottle B while holding with the bottle B an upper end portion of the label attached to the bottle B.

As shown in FIG. 3, the label opening unit 10 includes: a pair of openable and closable clamp members 11; a suction unit (not shown), which performs suction through suction openings formed in clamping portions 11a of the clamp members 11, thereby causing the clamp members 11 to hold by suction both sides of the label L clamped by the clamp members 11; and an opening and closing driving unit 12, which opens and closes the clamp members 11. In the label opening unit 10, after one of the clamp members 11 has held by suction and received at the second label delivery position β the label L folded in a sheet and conveyed by the label delivery device 4, the pair of clamp members 11 clamp the label L, and the suction unit operates to cause the clamping portions 11a to hold by suction both sides of the label L. In this state, the clamp members 11 open to separate both sides of the label L from each other, thereby opening the label L into a tubular shape.

It should be noted that as shown in FIGS. 1 and 2, in the label delivery device 4, a take-up member 4a, which rotates so as to pass through the first label delivery position α and the second label delivery position β, has at its extremity a comb-like label adhesion portion, which adheres one side of the sheet-like label L. The clamping portions 11a of the clamp members 11 sandwich the label L adhered by the label adhesion portion and separate the label L from the label adhesion portion. Consequently, the label L is delivered.

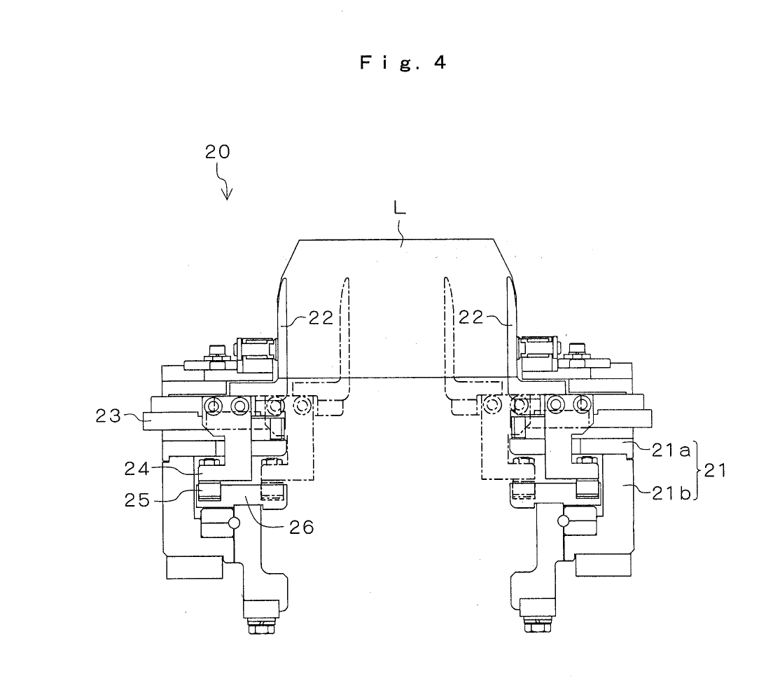

As shown in FIG. 4, the label expansion unit 20 includes: a base member 21, which includes an upper annular disk 21a and a lower tubular member 21b attached to a lower end portion of the upper annular disk 21a; eight expansion claws 22, which are supported by the annular disk 21a so as to be radially movable via sliding members 23; cam followers 25, which are attached to the respective sliding members 23 via supporting members 24; and an annular cam member 26, which is rotatably supported by an inner circular portion of the lower tubular member 21b, and to which the cam followers 25 fit, and in which a plurality of radial cam grooves extending circumferentially from the inner diameter to the outer diameter of the annular cam member 26 are formed. The cam member 26 is rotated by a cam mechanism (not shown), thereby causing the expansion claw 22 to radially advance or retreat.

As shown in FIG. 3, the label expansion unit 20 is supported so as to rise and fall by a supporting pillar attached to the supporting arm 5b. The label expansion unit 20 rises and falls by a rise and fall mechanism 27, which includes: a cam follower 28 attached to the lower tubular member 21b of the base member 21; and a cam member 29 having a cam surface that the cam follower 28 abuts.

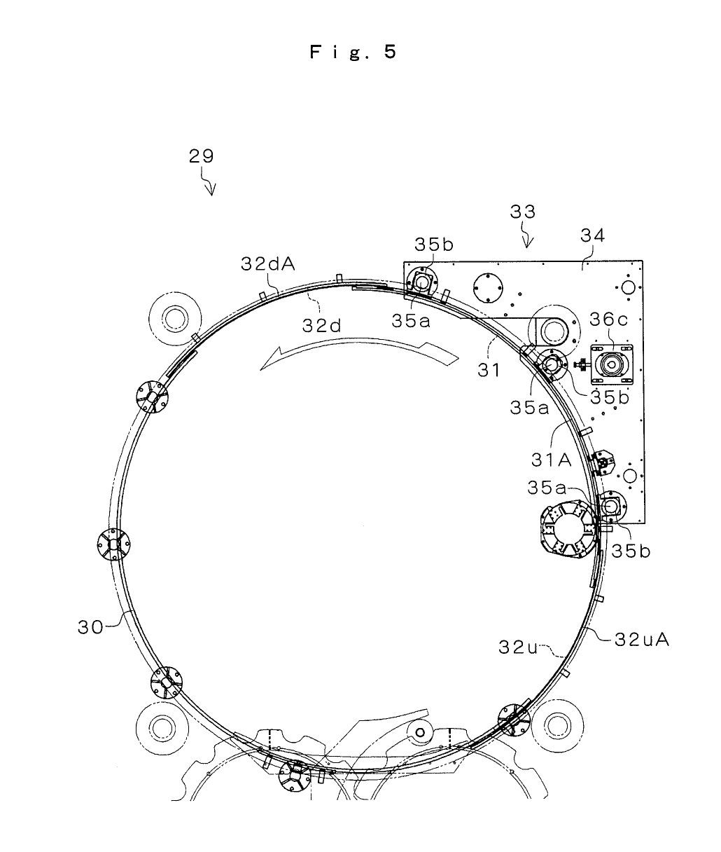

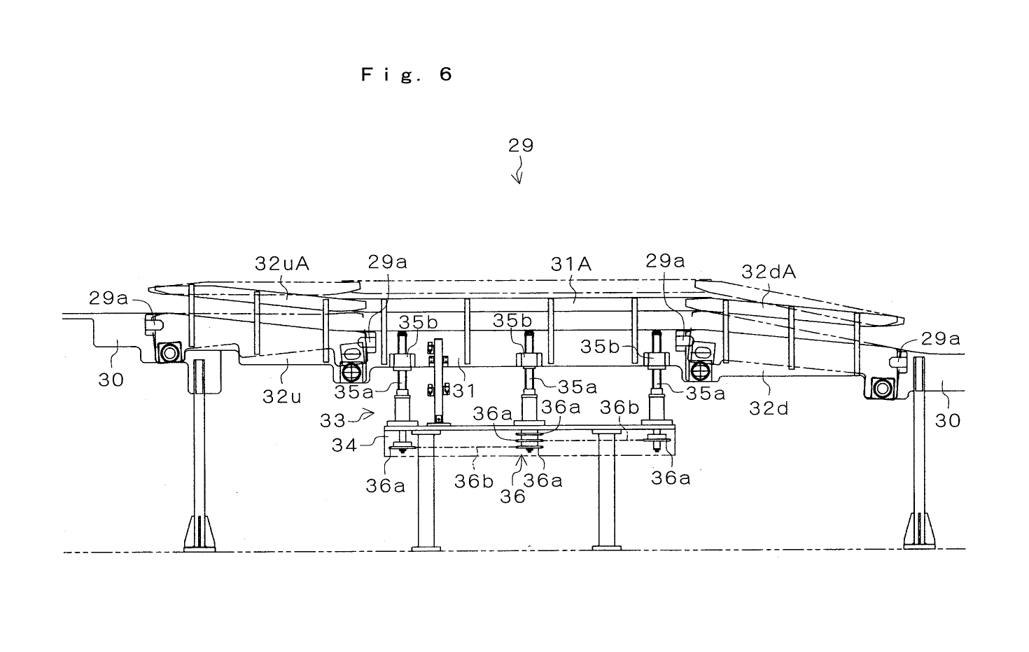

The cam member 29 is disposed along the movement path of the label expansion unit 20. As shown in FIGS. 5 and 6, the cam member 29 includes: a fixed portion 30, of which the height position cannot be changed; a rise and fall portion 31, of which the height position can be changed by a rise and fall mechanism 33; and connection portions 32u and 32d, which connect the fixed portion 30 and the rise and fall portion 31 so as to swing by following the rising and falling motion of the rise and fall portion 31.

The rise and fall portion 31 generally corresponds to the area between the position where the insertion of the bottle B into the label L expanded by the label expansion unit 20 starts (the position immediately after the bottle lifting unit 40 starts lifting the bottle B) and the position where the insertion of the bottle B is completed. The rise and fall portion 31 has a flat cam surface over the entire length. Thus, while the cam follower 28 is moving on the cam surface of the rise and fall portion 31, the expansion claws 22 of the label expansion unit 20 are maintained at the same height position.

The connection portion 32u corresponds to the area between the bottle supply position γ and the position where the insertion of the bottle B into the expanded label L starts (the position immediately after the bottle lifting unit 40 starts lifting the bottle B). The connection portion 32d corresponds to the area between the position where the insertion of the bottle B into the expanded label L is completed and the position immediately after the bottle pull-up unit 50 starts pulling up the bottle B. The rise and fall portion 31 rises and falls, thereby changing the angle of inclination of the cam surface at the connection portions 32u and 32d.

The area corresponding to the fixed portion 30 in the cam member 29 has only a cam surface that the lower surface of the cam follower 28 abuts. In other areas, that is, the areas corresponding to the connection portion 32u, the rise and fall portion 31, and the connection portion 32d, on the upper sides of the connection portion 32u, the rise and fall portion 31, and the connection portion 32d, a connection portion 32uA, a rise and fall portion 31A, and a connection portion 32dA connected to the connection portion 32u, the rise and fall portion 31, and the connection portion 32d, respectively, are disposed at predetermined intervals. Thus, the cam follower 28 moves between: the connection portion 32u, the rise and fall portion 31, and the connection portion 32d; and the connection portion 32uA, the rise and fall portion 31A, and the connection portion 32dA.

The rise and fall mechanism 33 includes: three screws 35a, which are provided in a standing manner on a supporting frame 34 so as to be rotatable; three nuts 35b, with which the respective screws 35a are threadably engaged and which are fixed to the rise and fall portion 31; and a drive mechanism 36, which rotates the three screws 35a. The drive mechanism 36 rotates the three screws 35a forward and backward, thereby causing the three nuts 35b to move up and down. Accordingly, the rise and fall portion 31 rises and falls.

The drive mechanism 36 includes: three sprockets 36a attached to a lower end portion of the screw 35a at the center; one sprocket 36a attached to each of the screws 35a on both sides; a chain 36b, which extends around the lowermost sprocket 36a of the screw 35a at the center and the sprocket 36a of the screw 35a on the upstream side; a chain 36b, which extends around the middle sprocket 36a of the screw 35a at the center and the sprocket 36a of the screw 35a on the downstream side; and a motor 36c, which rotates the screws 35a. The rotational driving force of the motor 36c is transmitted to the uppermost sprocket 36a of the screw 35a at the center via a chain (not shown), thereby causing the three screws 35a to rotate in the same direction.

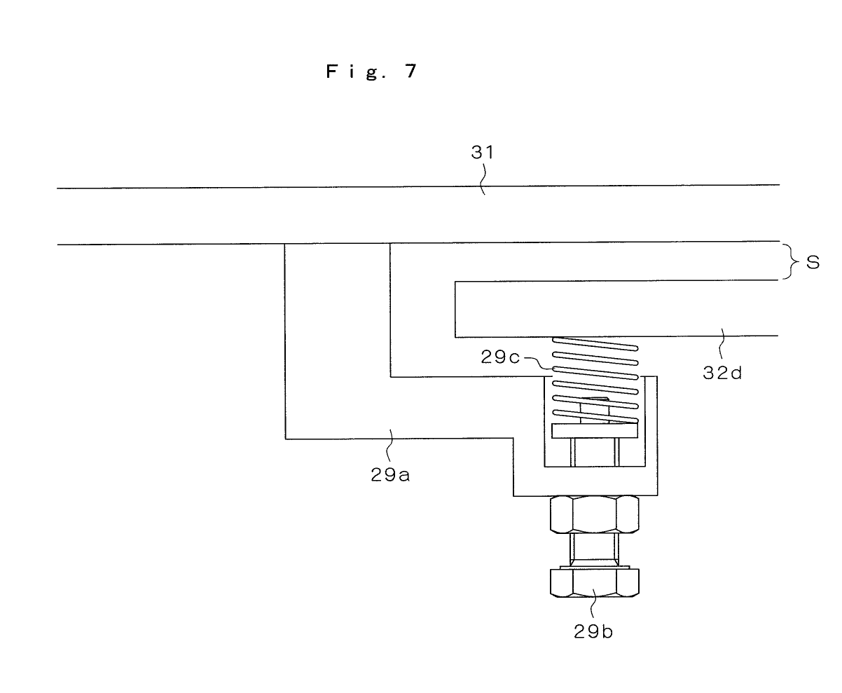

Further, the connection portions 32u and 32d each swing using the connecting point with the fixed portion 30 as a fulcrum. As shown in FIG. 5, however, the fixed portion 30, the rise and fall portion 31, and the connection portions 32u and 32d are curved arcuately along a concentric circle about the rotating shaft of the label attachment device 5. Thus, if the connection portions 32u and 32d each swing up and down using the connecting point with the fixed portion 30 as a fulcrum, the end portions of the connection portions 32u and 32d on the rise and fall portion 31 side move radially in accordance with the swinging motions. This may prevent a smooth swinging motion. In response, to absorb the radial movements of the end portions on the rise and fall portion 31 side, as shown in FIG. 7, some space S is formed between the end portion of the connection portion 32d on the rise and fall portion 31 side and the rise and fall portion 31, and the end portion of the connection portion 32d is moderately biased to the rise and fall portion 31 side by a coil spring 29c attached via an adjustment bolt 29b to a supporting member 29a fixedly provided in the rise and fall portion 31. Further, the end portion of the connection portion 32d on the fixed portion 30 side has a structure obtained by horizontally inverting the end portion on the rise and fall portion 31 side. Also both end portions of the connection portion 32u have the same structure as both end portions of the connection portion 32d.

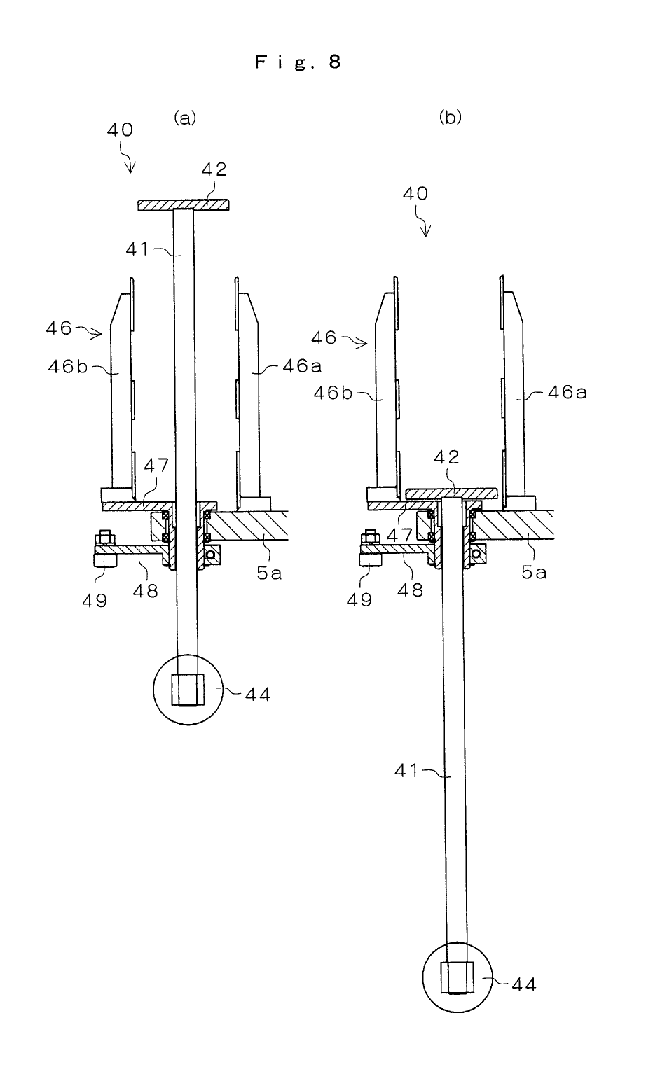

As shown in FIGS. 3 and 8, the bottle lifting unit 40 includes: an operation rod 41, which is supported so as to be movable up and down while penetrating a peripheral edge portion of the supporting disk 5a upward and downward; the mounting 42, on which the bottle B is mounted and which is attached to an upper end portion of the operation rod 41 on the upper side of the supporting disk 5a; and a rise and fall mechanism 43, which causes the operation rod 41 to rise and fall. The rise and fall mechanism 43 includes: a cam follower 44, which is attached to a lower end portion of the operation rod 41; and a cam plate 45, which has a cam groove into which the cam follower 44 fits.

Further, to prevent the bottle B mounted on the mounting 42 from falling over, an openable and closable bottle guide 46, which includes a fixed guide 46a and a movable guide 46b that surround the mounting 42, is disposed on the supporting disk 5a. Consequently, when the bottle B supplied from the bottle supply device 2 is received at the bottle supply position γ, the movable guide 46b opens so as not to hinder the reception of the bottle B.

The movable guide 46b is provided in a standing manner on a swinging lever 47 swingably supported by the supporting disk 5a via a bearing, with the operation rod 41 inserted so as to rise and fall. A cam follower 49, which is attached to a base end portion of the swinging lever 47 via a supporting member 48, abuts a cam surface of a cam member (not shown), thereby causing the swinging lever 47 to swing. Accordingly, the movable guide 46b opens and closes relative to the fixed guide 46a.

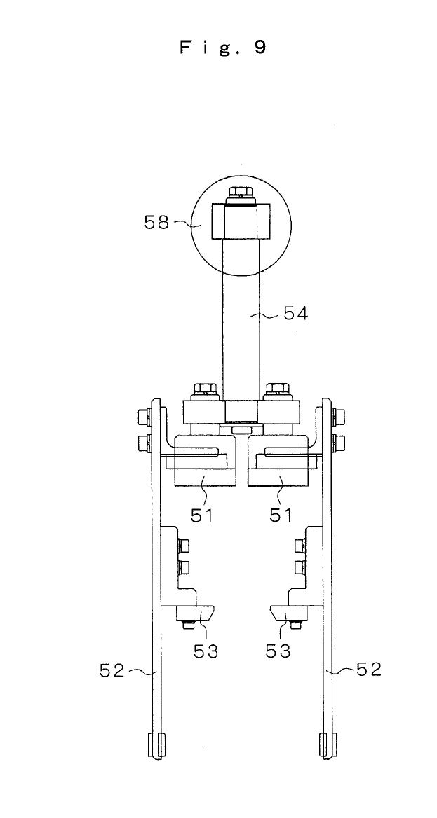

As shown in FIGS. 3 and 9, the bottle pull-up unit 50 includes: a pair of openable and closable swinging arms 51; a pair of left and right grippers 52, which are attached to extremity portions of the respective swinging arms 51 and hold an upper end portion of the label L on the main body portion of the bottle B on which the label L is attached; a pair of left and right neck clampers 53, which are attached to the respective grippers 52 and when the grippers 52 has held the bottle B, hold a neck portion of the bottle B; a rise and fall mechanism 57, which causes the swinging arms 51 to rise and fall; and an opening and closing mechanism 60, which opens and closes the swinging arms 51. The pair of left and right swinging arms 51 are supported so as to rise and fall by a slide rail 56 via a supporting member 54 and a slide guide 55, the slide rail 56 provided in a standing manner on the supporting arm 5b.

The rise and fall mechanism 57 includes: a cam follower 58, which is attached to the supporting member 54; and a cylindrical cam member 59, which has a cam groove 59a into which the cam follower 58 fits, the cam member 59 disposed along the movement paths of the grippers 52. A cam mechanism including the cam follower 58 and the cam member 59 (the cam groove 59a) moves up and down the slide guide 55, thereby causing the swinging arms 51 to rise and fall.

The opening and closing mechanism 60 includes: a spring (not shown), which always biases the swinging arms 51 in an opening direction; a pair of rollers (not shown), which are attached to the swinging arms 51 on the base end portion side; and an operation rod 61, to a lower end portion of which a cam member 62 is attached, the cam member 62 having a cam surface that abuts both rollers by being inserted between both rollers. The operation rod 61 is supported so as to be movable up and down by the supporting member 54, and a slide guide 63, which rises and falls along the slide rail 56, is attached to an upper end portion of the operation rod 61.

To the upper end portion of the operation rod 61, a cam follower 64, which fits into a cam groove 59b formed in the cam member 59, is attached. A cam mechanism including the cam follower 64 and the cam member 59 (the cam groove 59b) moves up and down the slide guide 63, thereby causing the operation rod 61 to rise and fall.

Thus, if the cam follower 64 has fallen using the cam groove 59b, then accordingly, the operation rod 61 falls, and the cam member 62 attached to the lower end portion of the operation rod 61 presses and spreads the rollers, thereby causing the swinging arms 51 to close on the extremity sides. Thus, the cam mechanism including the cam groove 59b and the cam follower 64 moves up and down the operation rod 61, thereby opening and closing the swinging arms 51.

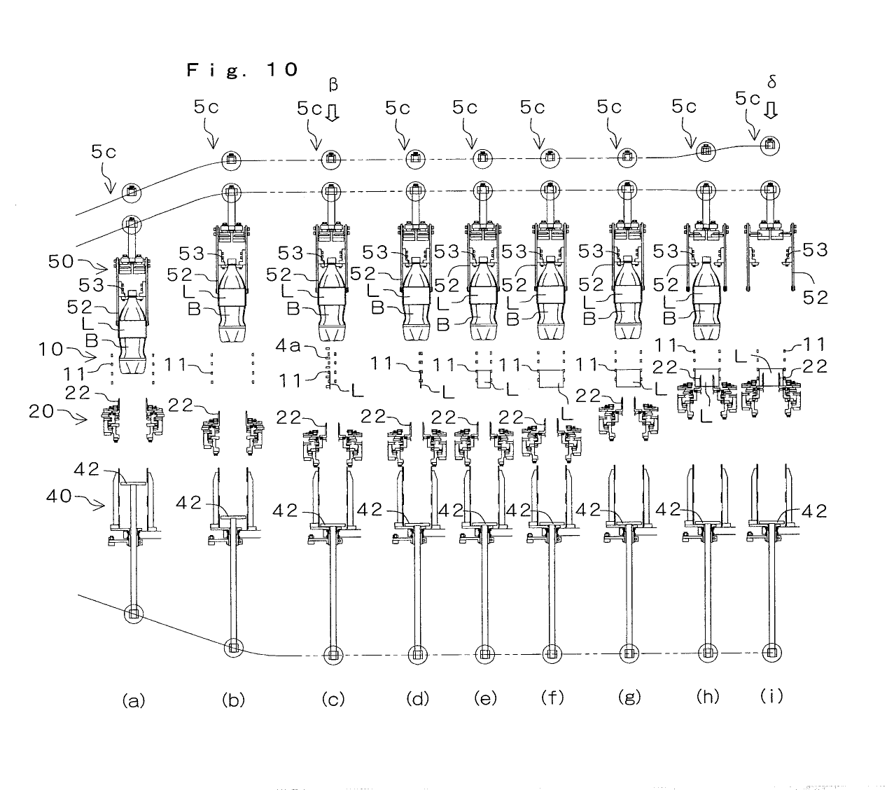

In the label attachment device 5 configured as described above, first, as shown in FIGS. 1 and 2, the clamp members 11 receive the tubular label L folded in a sheet and conveyed to the label delivery position β by the label delivery device 4. At the position immediately before the second label delivery position β, as shown in (a) and (b) of FIG. 10, the clamp members 11 are most open. While the label attachment head 5c is coming close to the label delivery position β, the bottle B to which the label L has been attached in the previous step is pulled up by the bottle pull-up unit 50, passes through between the pair of clamp members 11 that are open, and withdraws to above the clamp members 11. Then, the bottle B is conveyed at this height position to the bottle sending position δ (see (b) to (i) of FIG. 10), and the expansion claws 22 of the label expansion unit 20 fall to the lowest positions and close (see (a) to (c) of FIG. 10).

At the second label delivery position β, after, as shown in (c) of FIG. 10, one of the clamp members 11 has received the label L, conveyed by the take-up member 4a of the label delivery device 4, by holding by suction one side of the label L, then as shown in (d) of FIG. 10, the pair of clamp members 11 clamp the label L. Then, with the clamping portions 11a holding by suction both sides of the label L, as shown in (e) and (f) of FIG. 10, the clamp members 11 open to separate both sides of the label L from each other, thereby opening the label L into a tubular shape.

Subsequently, as shown in (g) and (h) of FIG. 10, the expansion claws 22 in a closed state gradually rise and are inserted into the label L that is in an open state and held by suction by the clamp members 11. Then, as shown in (h) and (i) of FIG. 10, the grippers 52 of the bottle pull-up unit 50 open to release the holding of the main body portion and the neck portion of the bottle B. Then, at the bottle sending position 5, the bottle B to which the label L is attached is delivered to the star wheel 6a of the bottle conveyance device 6.

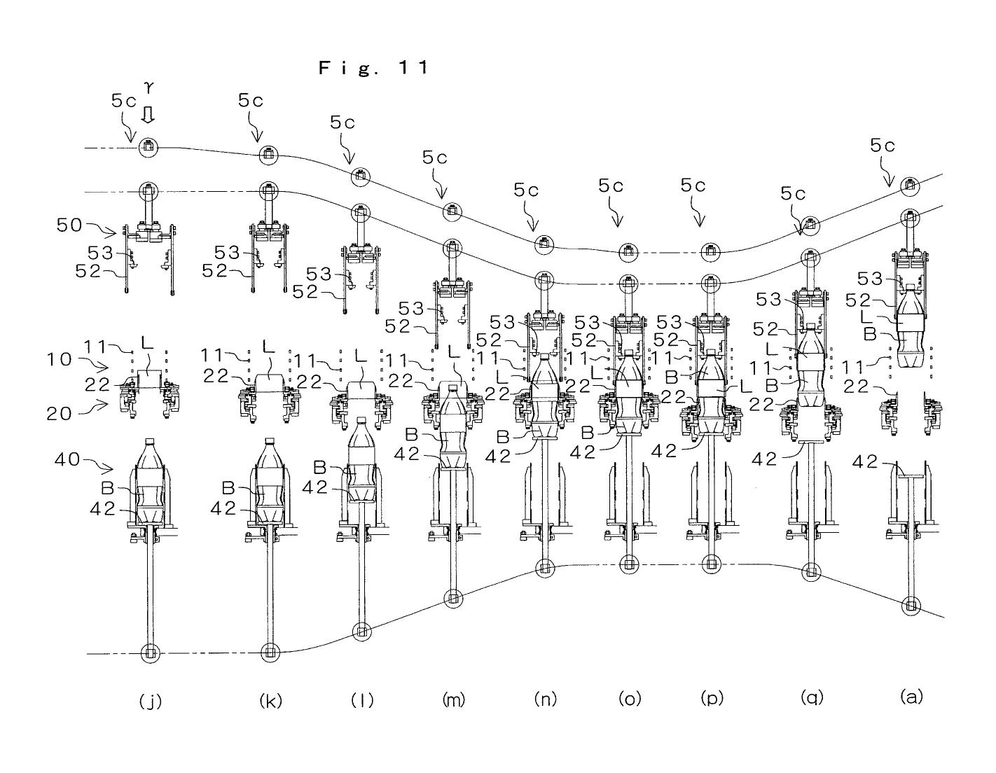

Then, as shown in (j) to (l) of FIG. 11, the expansion claws 22 that are in the closed state and inserted into the label L in the open state open, thereby expanding the label L while falling to the label attachment level. Meanwhile, at the bottle supply position γ, a new bottle B delivered from the bottle supply device 2 becomes mounted on the mounting 42 of the bottle lifting unit 40.

If the label L has thus been expanded at the label attachment level, then as shown in (l) to (o) of FIG. 11, the mounting 42 on which the bottle B is mounted rises, thereby inserting the bottle B into the expanded label L. Meanwhile, the grippers 52 of the bottle pull-up unit 50 fall, the pair of left and right grippers 52 hold the upper end portion of the label L on the main body portion of the bottle B on which the label L is attached, and the pair of left and right neck clampers 53 attached to the grippers 52 hold the neck portion of the bottle B.

Subsequently, after, as shown in (p) of FIG. 11, the expansion claws 22 have fallen from the label attachment level to pull the expansion claws 22 out of the label L attached to the bottle B, then as shown in (q) of FIG. 11, the grippers 52 and the neck clampers 53 holding the main body portion and the neck portion of the bottle B rise, thereby starting to pull up the bottle B. Meanwhile, the mounting 42 starts falling. Subsequently, the expansion claws 22 rise to the label attachment level, whereby the process returns to an initial state shown in (a) of FIG. 11 ((a) of FIG. 10).

As described above, in the label attachment device 5, the cam member 29 included in the rise and fall mechanism 27 of the label expansion unit 20 (the expansion claws 22) includes: the fixed portion 30, of which the height position cannot be changed; the rise and fall portion 31, of which the height position can be changed by the rise and fall mechanism 33; and the connection portions 32u and 32d, which connect the fixed portion 30 and the rise and fall portion 31 so as to swing by following the rising and falling motion of the rise and fall portion 31. Moreover, the rise and fall portion 31 generally corresponds to the area between the position where the insertion of the bottle B into the label L expanded by the label expansion unit 20 starts (the position immediately after the bottle lifting unit 40 starts lifting the bottle B) and the position where the insertion of the bottle B is completed, that is, the operating range in (l) to (o) of FIG. 11. Meanwhile, the connection portion 32u corresponds to the area between the bottle supply position γ and the position where the insertion of the bottle B into the expanded label L starts (the position immediately after the bottle lifting unit 40 starts lifting the bottle B), that is, the operating range in (j) to (l) of FIG. 11. The connection portion 32d corresponds to the area between the position where the insertion of the bottle B into the expanded label L is completed and the position immediately after the bottle pull-up unit 50 starts pulling up the bottle B, that is, the operating range in (o) to (q) of FIG. 11. Thus, the rise and fall mechanism 33 changes the height position of the rise and fall portion 31, and thereby can adjust the position of attachment of the label L relative to the bottle B, that is, the label attachment level. Thus, a user themselves can perform a model changing operation more easily than exchanging the entirety of the cam member 29. Moreover, since the cam member 29 is not a fixed cam member, the user themselves is enabled to finely adjust the position of attachment of a label.

Particularly, in the cam member 29, even if the rise and fall portion 31 has risen and fallen, merely the inclination of each of the connection portions 32u and 32d changes. However, the timing at which the insertion of the bottle B into the expanded label L starts (the timing at which the mounting 42 starts rising) and the timing at which the insertion of the bottle B is completed do not change. This can prevent the occurrence of a wasted movement time and a wasted movement space. This makes it possible to efficiently operate the label attachment device.

It should be noted that in the above embodiment, the rise and fall portion 31 of the cam member 29 generally corresponds to the area between the position where the insertion of the bottle B into the label L expanded by the label expansion unit 20 starts (the position immediately after the bottle lifting unit 40 starts lifting the bottle B) and the position where the insertion of the bottle B is completed. The invention, however, is not limited to this. Alternatively, the end portion of the rise and fall portion 31 on the upstream side may correspond to the position before the bottle lifting unit 40 starts lifting the bottle B, and the end portion of the rise and fall portion 31 on the downstream side may correspond to the position after the bottle lifting unit 40 stops lifting the bottle B.

As described above, however, in the case where the end portion of the rise and fall portion 31 on the downstream side corresponds to the position after the lifting of the bottle B to the label L is stopped, if a cam surface is formed in the rise and fall portion 31 such that the expansion claws 22 fall to the label attachment level after the lifting of the bottle B is stopped, the timing of attachment of the bottle B to the label L may be delayed. Thus, it is desirable that in the rise and fall portion 31, a cam surface should be formed such that the expansion claws 22 fall to the label attachment level before the lifting of the bottle B is stopped.

Further, in the above embodiment, the height position of the label expansion unit 20 (the expansion claws 22) during the rising motion of the mounting 42 when the bottle B is inserted into the label L is adjusted, thereby adjusting the position of attachment of the bottle B to the label L, that is, the label attachment level. The invention, however, is not limited to this. Alternatively, the height of the stoppage of the rise of the mounting 42 when the bottle B is inserted into the label L can be adjusted, thereby adjusting the position of attachment of the label L to the bottle B. In this case, similarly to the cam member 29 described above, the cam plate 45 of the rise and fall mechanism 43 that causes the mounting 42 to rise and fall may include: a fixed portion, of which the height position cannot be changed; a rise and fall portion, of which the height position can be changed; and a connection portion, which connects the fixed portion and the rise and fall portion so as to swing by following the rising and falling motion of the rise and fall portion. Then, the rise and fall portion may rise and fall, thereby adjusting the height position of the stoppage of the mounting 42.

Further, in the above embodiments, the descriptions are given of a label attachment device of a type that lifts the bottle B from the lower side to insert the bottle B into the label L expanded at the label attachment level. The invention, however, is not limited to this. The present invention is also applicable to a label attachment device of a type in which the label expansion unit 20 that is expanding the label L falls, thereby attaching the label L onto the bottle B mounted on the lower side.

In the case of the label attachment device of a type that thus causes a label to fall to attach the label onto a bottle, a rise and fall mechanism that causes expansion claws to rise and fall may include: a cam follower, which is attached to a label expansion unit; and a cam, which is disposed along the movement paths of the expansion claws and guides the cam follower. Similarly to the cam member 29 described above, the cam may include: a fixed portion, of which the height position cannot be changed; a rise and fall portion, of which the height position can be changed; and a connection portion, which connects the fixed portion and the rise and fall portion so as to swing by following the rising and falling motion of the rise and fall portion. Then, the rise and fall portion may rise and fall, thereby adjusting the height of the stoppage of the fall of the expansion claws. Further, a rise and fall mechanism for a mounting may be provided so as to include: a cam follower, which is attached directly or via another member to the mounting; and a cam, which guides the cam follower. Similarly to the cam member 29 described above, the cam may include: a fixed portion, of which the height position cannot be changed; a rise and fall portion, of which the height position can be changed; and a connection portion, which connects the fixed portion and the rise and fall portion so as to swing by following the rising and falling motion of the rise and fall portion. Then, the rise and fall portion may rise and fall, thereby adjusting the height position of the mounting.

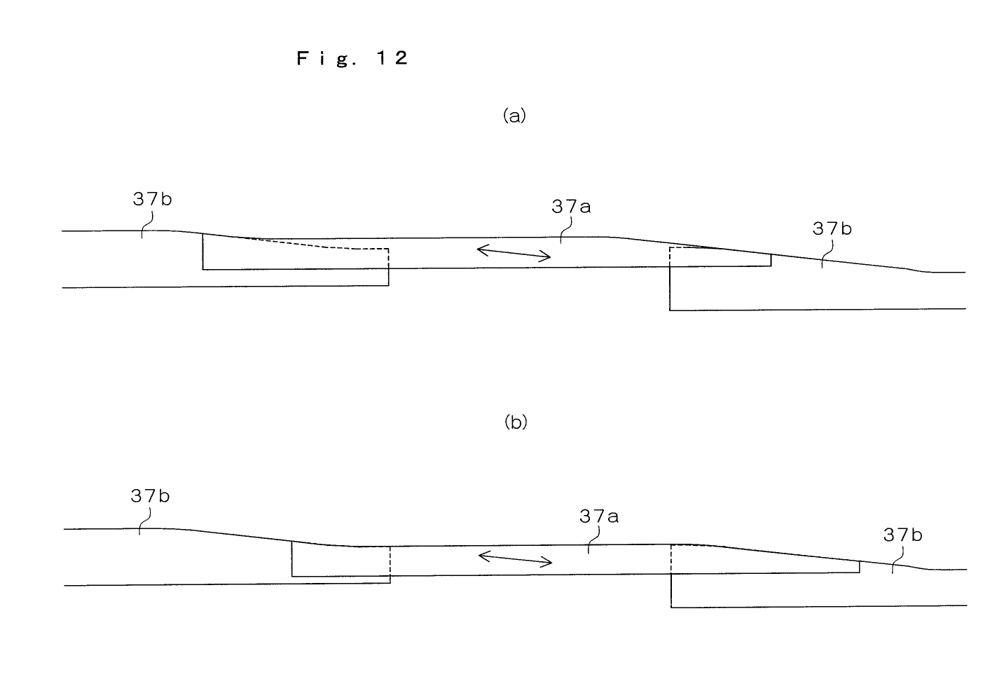

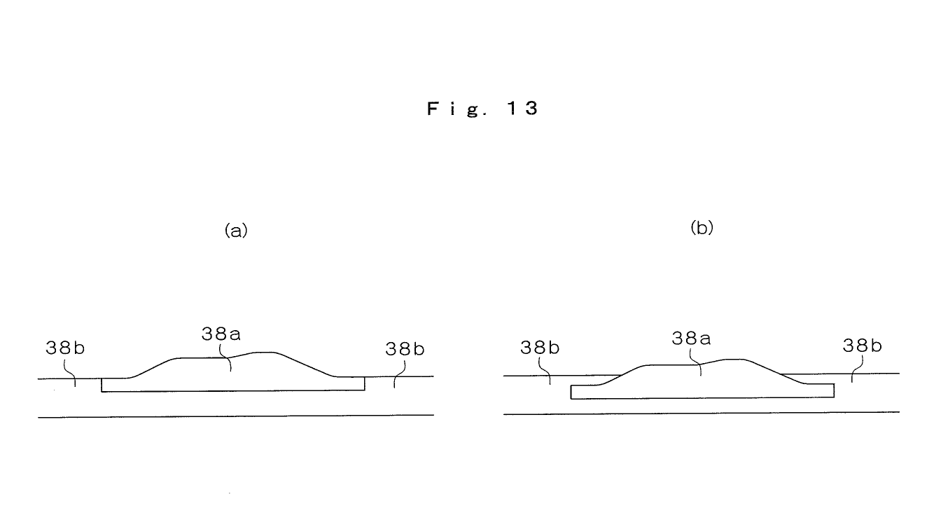

Further, in the above embodiments, as a cam included in a rise and fall unit that causes expansion claws or a mounting to rise and fall, a cam is used that includes: a fixed portion, of which the height position cannot be changed; a rise and fall portion, of which the height position can be changed; and a connection portion, which connects the fixed portion and the rise and fall portion so as to swing by following the rising and falling motion of the rise and fall portion. The invention, however, is not limited to this. Alternatively, for example, as shown in (a) and (b) of FIG. 12, a cam may be used in which a portion corresponding to the operation of inserting a bottle into a label or a portion corresponding to the operation of attaching a label onto a bottle is a movable portion 37a, which is slidable obliquely upward and downward. Then, a rise and fall unit (not shown) may slide the movable portion 37a obliquely upward and downward relative to a fixed portion 37b, as shown in arrows in FIG. 12. Yet alternatively, as shown in (a) and (b) of FIG. 13, a cam may be used in which a portion corresponding to the operation of inserting a bottle into a label or a portion corresponding to the operation of attaching a label onto a bottle is a movable portion 38a, which is slidable upward and downward. Then, a rise and fall unit (not shown) may slide the movable portion 38a upward and downward relative to a fixed portion 38b. It should be noted that as each rise and fall unit, an automatically-operated or manually-operated rise and fall mechanism, an adjustment mechanism using long holes, and the like may be employed. For example, as shown in FIG. 12, to slide the movable portion 37a obliquely upward and downward, the movable portion 37a may be supported so as to be slidable obliquely upward and downward, and a chain may be obliquely attached to the movable portion 37a, so that a sprocket meshing with the chain may be rotated at a fixed position by a motor. Alternatively, a manually-operated handle may be attached instead of a motor, and a sprocket may be rotated at a fixed position by a handle operation. Further, in the adjustment mechanism using long holes, long holes may be formed in both end portions of the movable portion 37a so as to extend in an oblique direction, and bolts screwed into the fixed portion 37b through the long holes may be tightened, thereby adjusting the position of the movable portion 37a.

For example, in a label attachment device of a type that lifts a bottle from the lower side to insert the bottle into a label expanded at the label attachment level, the height position of a label expansion unit (expansion claws) during the rising motion of a mounting when the bottle is inserted into the label may be adjusted, thereby adjusting the position of attachment of the label to the bottle. In this case, as a rise and fall mechanism that causes the label expansion unit (expansion claws) to rise and fall, a cam mechanism may be employed that includes: a cam follower, which is attached to the label expansion unit; and a cam, which is disposed along the movement paths of the expansion claws and guides the cam follower. In addition, a cam may be used in which a portion corresponding to the operation of inserting the bottle into the label is a movable portion that is slidable obliquely upward and downward or slidable upward and downward. The movable portion may be slid obliquely upward and downward or slid upward and downward, thereby adjusting the height positions of the expansion claws to adjust the position of attachment of the label to the bottle.

Further, in a label attachment device of a type that lifts a bottle from the lower side to insert the bottle into a label expanded at the label attachment level, the position of the stoppage of the rise of a mounting when the bottle is inserted into the label may be adjusted, thereby adjusting the position of attachment of the label to the bottle. In this case, as a cam included in a rise and fall mechanism (cam mechanism) for the mounting, a cam may be employed in which a portion corresponding to the operation of inserting an attachment target object into the label is a movable portion that is slidable obliquely upward and downward or slidable upward and downward. The movable portion may be slid obliquely upward and downward or slid upward and downward, thereby adjusting the position of the stoppage of the rise of the mounting to adjust the position of attachment of the label to the bottle.

Further, in a label attachment device of a type that causes expansion claws expanding a label to fall, thereby attaching the label onto a bottle mounted on the lower side, the position of the stoppage of the fall of the expansion claws when the label is attached onto the bottle may be adjusted, thereby adjusting the position of attachment of the label to the bottle. In this case, as a cam included in a rise and fall mechanism (cam mechanism) for the expansion claws, a cam may be employed in which a portion corresponding to the operation of inserting an attachment target object into the label is a movable portion that is slidable obliquely upward and downward or slidable upward and downward. The movable portion may be slid obliquely upward and downward or slid upward and downward, thereby adjusting the position of the stoppage of the fall of the expansion claws to adjust the position of attachment of the label to the bottle.

Further, in a label attachment device of a type that causes expansion claws expanding a label to fall, thereby attaching the label onto a bottle mounted on the lower side, the height position of a mounting during the falling motions of the expansion claws when the label is attached onto the bottle may be adjusted, thereby adjusting the position of attachment of the label to the bottle. In this case, as a rise and fall mechanism that causes the mounting to rise and fall, a cam mechanism may be employed that includes: a cam follower, which is attached directly or via another member to the mounting; and a cam, which is disposed along the movement path of the mounting and guides the cam follower. In addition, a cam may be used in which a portion corresponding to the operation of attaching the label onto the bottle is a movable portion that is slidable obliquely upward and downward or slidable upward and downward. The movable portion may be slid obliquely upward and downward or slid upward and downward, thereby adjusting the height position of the mounting to adjust the position of attachment of the label to the bottle.

Further, in the above embodiments, the case is described where a stretch label is attached to a PET bottle. An attachment target object, however, is not limited to a PET bottle as described above. It goes without saying that alternatively, the label attachment device according to the present invention can be applied to the case where a stretch label is attached to various containers such as a jar and a can, and a tubular object.

### INDUSTRIAL APPLICABILITY

The invention can be applied to a label attachment device that attaches a stretch label to an attachment target object such as a jar or a bottle.

### DESCRIPTION OF THE REFERENCE CHARACTERS

1 label attachment system
2 bottle supply device
2a belt conveyor
2b screw
2c star wheel
3 label supply device
4 label delivery device
4a take-up member
5 label attachment device
5a supporting disk
5b supporting arm
5c label attachment head
6 bottle conveyance device
6a star wheel
6b belt conveyor
10 label opening unit
11 clamp member
11a clamping portion
12 opening and closing driving unit
20 label expansion unit
21 base member
21a upper annular disk
21b lower tubular member
22 expansion claw
23 sliding member
24 supporting member
25 cam follower
26 cam member
27 rise and fall mechanism
28 cam follower
29 cam member
29a supporting member
29b adjustment bolt
29c coil spring
30 fixed portion
31, 31A rise and fall portion
32u, 32d, 32uA, 32dA connection portion
33 rise and fall mechanism
34 supporting frame
35a screw
35b nut
36 drive mechanism
36a sprocket
36b chain
36c motor
37a, 38a movable portion
37b, 38b fixed portion
40 bottle lifting unit
41 operation rod
42 mounting
43 rise and fall mechanism
44 cam follower
45 cam plate
46 bottle guide
46a fixed guide
46b movable guide
47 swinging lever
48 supporting member
49 cam follower
50 bottle pull-up unit
51 swinging arm
52 gripper
53 neck clamper
54 supporting member
55 slide guide
56 slide rail
57 rise and fall mechanism
58 cam follower
59 cam member
59a, 59b cam groove
60 opening and closing mechanism
61 operation rod
62 cam member
63 slide guide
64 cam follower
B bottle
L stretch label

1-8. (canceled)

9. A label attachment device comprising:
a label opening unit configured to preliminarily open a tubular label supplied as folded in a sheet;
a label expansion unit having openable and closable expansion claws configured to expand the label preliminarily opened by the label opening unit; and
a mounting, on which an attachment target object is mounted and which can rise and fall, wherein
the mounting on which the attachment target object is mounted rises, thereby inserting the attachment target object into the tubular label expanded by the expansion claws, and the expansion claws are removed from the label, thereby attaching the label to the attachment target object that is moving along a predetermined movement path,
the label attachment device further comprises a rise and fall mechanism configured to cause the expansion claws to rise and fall,
the rise and fall mechanism includes: a cam follower attached to the label expansion unit; and a cam disposed along movement paths of the expansion claws and configured to guide the cam follower,
the cam includes an adjustment mechanism which adjusts height positions of the expansion claws,
the adjustment mechanism adjusts height positions of the expansion claws, and thereby can adjust a position of attachment of the label to the attachment target object.

10. The label attachment device according to claim 9, wherein
the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and
the rise and fall portion adjusts height positions of the expansion claws.

11. The label attachment device according to claim 9, wherein
in the cam including the adjustment mechanism, a portion corresponding to an operation of inserting the attachment target object into the tubular label is a movable portion slidable obliquely upward and downward or slidable upward and downward, so that the movable portion is slid obliquely upward and downward or slid upward and downward, thereby adjusting height positions of the expansion claws.

12. A label attachment device comprising:
a label opening unit configured to preliminarily open a tubular label supplied as folded in a sheet;
a label expansion unit having openable and closable expansion claws configured to expand the label preliminarily opened by the label opening unit; and
a mounting, on which an attachment target object is mounted and which can rise and fall, wherein
the mounting on which the attachment target object is mounted rises, thereby inserting the attachment target object into the tubular label expanded by the expansion claws, and the expansion claws are removed from the label, thereby attaching the label to the attachment target object that is moving along a predetermined movement path,
the label attachment device further comprises a rise and fall mechanism configured to cause the mounting to rise and fall,
the rise and fall mechanism includes: a cam follower attached directly or via another member to the mounting; and a cam disposed along a movement path of the mounting and configured to guide the cam follower,
the cam includes an adjustment mechanism which adjusts a height position of a stoppage of the mounting,
when the mounting on which the attachment target object is mounted rises to insert the attachment target object into the tubular label, the adjustment mechanism adjusts a height position of a stoppage of the mounting, and thereby can adjust a position of attachment of the label to the attachment target object.

13. The label attachment device according to claim 12, wherein
the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and
the rise and fall portion adjusts a height position of a stoppage of the mounting.

14. The label attachment device according to claim 12, wherein
in the cam including the adjustment mechanism, a portion corresponding to an operation of inserting the attachment target object into the tubular label is a movable portion slidable obliquely upward and downward or slidable upward and downward, so that the movable portion is slid obliquely upward and downward or slid upward and downward, thereby adjusting a position of a stoppage of a rise of the mounting.

15. A label attachment device comprising:
a label opening unit configured to preliminarily open a tubular label supplied as folded in a sheet;
a label expansion unit having openable and closable expansion claws configured to expand the label preliminarily opened by the label opening unit; and
a mounting, on which an attachment target object is mounted, wherein
the expansion claws fall with the tubular label expanded, thereby attaching the tubular label onto the attachment target object, and the expansion claws are removed from the label, thereby attaching the label to the attachment target object that is moving along a predetermined movement path,
the label attachment device further comprises a rise and fall mechanism configured to cause the expansion claws to rise and fall,
the rise and fall mechanism includes: a cam follower attached to the label expansion unit; and a cam disposed along movement paths of the expansion claws and configured to guide the cam follower,
the cam includes an adjustment mechanism which adjusts a height position of a stoppage of the expansion claws,
when the expansion claws expanding the tubular label fall to attach the tubular label onto the attachment target object, the adjustment mechanism adjusts a height position of a stoppage of the expansion claws.

16. The label attachment device according to claim 15, wherein
the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and
the rise and fall portion adjusts a height position of a stoppage of the expansion claws.

17. The label attachment device according to claim 15, wherein
in the cam including the adjustment mechanism, a portion corresponding to an operation of attaching the tubular label onto the attachment target object is a movable portion slidable obliquely upward and downward or slidable upward and downward, so that the movable portion is slid obliquely upward and downward or slid upward and downward, thereby causing the expansion claws expanding the tubular label to fall to adjust a position of a stoppage of the fall of the expansion claws when the tubular label is attached onto the attachment target object.

18. A label attachment device comprising:
a label opening unit configured to preliminarily open a tubular label supplied as folded in a sheet;
a label expansion unit having openable and closable expansion claws configured to expand the label preliminarily opened by the label opening unit; and
a mounting, on which an attachment target object is mounted, wherein
the expansion claws fall with the tubular label expanded, thereby attaching the tubular label onto the attachment target object, and the expansion claws are removed from the label, thereby attaching the label to the attachment target object that is moving along a predetermined movement path,
the label attachment device further comprises a rise and fall mechanism configured to cause the mounting to rise and fall,
the rise and fall mechanism includes: a cam follower attached directly or via another member to the mounting; and a cam disposed along a movement path of the mounting and configured to guide the cam follower,
the cam includes an adjustment mechanism which adjusts height positions of the mounting,
the adjustment mechanism adjusts a height position of the mounting, and thereby can adjust a position of attachment of the label to the attachment target object.

19. The label attachment device according to claim 18, wherein
the cam including the adjustment mechanism includes: a fixed portion, of which a height position cannot be changed; a rise and fall portion, of which a height position can be changed; and a connection portion, which connects the fixed portion and the rise and fall portion so as to swing by following a rising and falling motion of the rise and fall portion, and
the rise and fall portion adjusts a height position of the mounting.

20. The label attachment device according to claim 18, wherein
in the cam including the adjustment mechanism, a portion corresponding to an operation of attaching the tubular label onto the attachment target object is a movable portion slidable obliquely upward and downward or slidable upward and downward, so that the movable portion is slid obliquely upward and downward or slid upward and downward, thereby adjusting a height position of the mounting.
